(19) United States
(12) Patent Application Publication
(10) Pub. No.: US 2026/0032029 A1
(43) Pub. Date: Jan. 29, 2026

(54) METHODS AND SYSTEMS FOR GENERATING OTFDM SYMBOL USING SPREAD DATA/ CONTROL AND RS

(71) Applicant: WISIG NETWORKS PRIVATE LIMITED, Madinaguda, Hyderabad (IN)

(72) Inventors: SaiDhiraj Amuru, Manikonda, Hyderabad (IN); Koteswara Rao Gudimitla, Srikalahasti, Andhra Pradesh (IN); Sibgath Ali Khan Makandar, Hyderabad, Telangana (IN); Kiran Kumar Kuchi, Madinaguda, Hyderabad (IN); Sakshama Ghoslya, Jaipur, Rajasthan (IN)

(21) Appl. No.: 18/996,319

(22) PCT Filed: Aug. 7, 2023
(86) PCT No.: PCT/IN2023/050757

§ 371 Date: Jan. 17, 2025

(30) Foreign Application Priority Data
Aug. 5, 2022 (IN) 202241044732

(51) Int. Cl. H04L 27/20; H04L 5/00; H04L 27/26

(52) U.S. Cl. CPC H04L 27/20; H04L 5/0048; H04L 27/2607; H04L 27/2634

(57) ABSTRACT

Embodiments of the present disclosure relate to a method for transmitting a waveform. The method comprising generating. The method comprising generating, by a transmitter, at least one of: at least one input data or control and at least one reference sequence (RS). Also, the method comprises performing spreading operation on the at least one input data or control with a spread sequence to generate at least one spread data or control sequence and time-multiplexing the at least one spread data or control sequence with the at least one RS, to generate a multiplexed sequence. Further, the method comprises generating an OTFDM symbol using the multiplexed sequence. Also, the method transmits the RS and the data or control in one OTFDM symbol, which eventually offers low PAPR, spreading gain and low latency.

### CROSS-REFERENCE TO RELATED APPLICATIONS

This application claims priority from the Indian Provisional Patent Application Number 202241044732 filed on Aug. 5, 2022, the entirety of which are hereby incorporated by reference.

### TECHNICAL FIELD

Embodiments of the present disclosure are related, in general to communication, but exclusively relate to methods and systems for generating and transmitting pre Discrete Fourier Transform (DFT) reference sequence (RS) and Data multiplexed OTFDM with spreading.

### BACKGROUND

3GPP (3rd Generation Partnership Project) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. In DFT-s-OFDM, the data is first precoded by taking a DFT of allocation size before mapping the data to the allocated sub-carriers. The DFT-s-OFDM is essentially a single carrier modulation scheme. Hence, DFT-s-OFDM has lower PAPR compared to OFDM. Furthermore, DFT-s-OFDM has similar robustness to the frequency selective fading as OFDM as cyclic prefix is introduced to reduce Inter Symbol Interference (ISI).

To further reduce the PAPR of DFT-s-OFDM waveform, waveform-based solutions like Pi/2-BPSK modulation is used to modulate the user data. On the DFT precoded pi/2-BPSK symbols spectrum shaping filter is applied to reduce the PAPR further. Low PAPR allows the signal to be transmitted at higher transmitting power by reducing the PA power back-off. However, spectrum shaping along with DFT precoding may not show much effect on the PAPR of higher modulation schemes resulting in no improvement in increasing the transmit signal power. Additionally, current 5G standards uses slot structure, where user data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve extremely low latency, it is desirable to transmit the information (like user data, RS, and control information) in a single shot i.e., using a single OFDM symbol. However, conventional DFT-S-OFDM requires at least one data symbol and at least one reference symbol (RS). The RS is required for the purpose of estimating the channel state information (CSI) and subsequent equalization of data symbol. The current two-symbol structure in 5G-NR not only doubles the latency (compared to single symbol case), but also has a higher RS overhead i.e., 50%. There is a need for a waveform that allows one transmission with flexible RS overhead and high-power efficiency.

6G system is required to support a low PAPR waveform that not only has low PAPR but also enables reliable control channel decoding at high interference levels and the waveform should allow support multiple users using the available time-frequency resources simultaneously.

In addition, 6G Systems require a waveform that can be used for sensing purposes along with communications. The waveform used for sensing should have low PAPR. Therefore, a low-PAPR waveform that enables integrated sensing and communications is required.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting a waveform is disclosed. The method comprising generating, by a transmitter, at least one of: at least one input data and at least one reference sequence (RS). Also, the method comprises performing spreading operation on the at least one input data with a spread sequence to generate at least one spread data sequence and time-multiplexing the at least one spread data sequence with the at least one RS, to generate a multiplexed sequence. Further, the method comprises generating an OTFDM symbol using the multiplexed sequence. In an embodiment, the OTFDM symbol, may be referred to as a OFDM symbol and OTFDM symbol number may be referred to as OTFDM symbol number.

In another aspect of the present disclosure a method for receiving a waveform is provided. The method comprising performing, by the receiver, a Fast Fourier Transform (FFT) on received time multiplexed waveform to obtain a transformed sequence. Also, the method comprises performing de-mapping operation using a plurality of sub-carriers to generate a de-mapped sequence. Further, the method comprises estimating a channel using the de-mapped sequence based on an estimation method and equalizing the de-mapped sequence using the estimated channel to obtain an equalized sequence. Further, de-spreading the equalized sequence to obtain a de-spread sequence.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows a block diagram of a transmitter for each user with data in one OFDM symbol with spectrum shaping and excess bandwidth, in accordance with an embodiment of the present disclosure;

FIG. 1A shows a block diagram of an OTFDM transmitter, in accordance with an exemplary embodiment of the present disclosure;

FIG. 1B shows a block diagram of an OTFDM symbol generating unit, in accordance with an embodiment of the present disclosure;

FIG. 1C shows a block diagram of a processing unit of the OTFDM symbol generating unit as shown in FIG. 1B, in accordance with an embodiment of the present disclosure;

FIG. 2A shows the generation of a single OTFDM symbol, in accordance with an embodiment of the present disclosure;

FIG. 2B shows the generation of one or more OTFDM symbols, in accordance with an embodiment of the present disclosure;

FIG. 2C shows the generation of multiplexed OTFDM symbols from multiple transmitters, in accordance with another embodiment of the present disclosure;

FIG. 3A shows a symbol with DMRS in the middle of OFDM symbol along with pre-fix and post-fix;

FIG. 3B shows a symbol with two RS chunks at the symbol boundaries and data in the middle of OFDM symbol;

FIG. 3C shows a Symbol with RS with pre-fix and post-fix at ¼th and ¾th positions of OFDM symbol;

FIG. 3D shows a Symbol with RS with pre-fix and post-fix starting at 0th and ½th positions of OFDM symbol;

FIG. 3E shows a Symbol with two RS chunks at the symbol boundaries, one in the middle for channel estimation;

FIG. 3F shows Symbol with two RS chunks at the symbol boundaries and data in the middle of OFDM symbol for phase tracking;

FIG. 3G shows a symbol with RS with pre-fix and post-fix at ¼th of symbol along with RS without CP for phase tracking;

FIG. 3H shows a symbol with two RS chunks at the symbol boundaries for phase tracking, one in the middle for channel estimation;

FIG. 3I shows a symbol with two RS chunks at the symbol boundaries, one in the middle for phase tracking;

FIG. 3J shows symbol with multiple RS chunks multiplexed with data;

FIG. 4 shows a block diagram of a receiver for receiving for Data and RS multiplexed in one OFDM symbol;

FIG. 5 an illustration of obtaining M samples from M+d samples;

FIG. 6 shows a receiver receiving for Data and RS multiplexed in one OFDM symbol with spectrum extension shaping and receiver spectrum shaping;

FIG. 7 shows a receiver for receiving two RS chunks, with estimation on each RS chunk;

FIG. 8 shows a receiver for receiving RS chunks, with phase estimation on secondary RS chunk; and

FIG. 9 shows a flowchart illustrating a method for transmitting a waveform in a communication network, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure relate to a method for transmitting a waveform. The method comprising generating, by a transmitter, at least one of: at least one input data and at least one reference sequence (RS). Also, the method comprises performing spreading operation on the at least one input data with a spread sequence to generate at least one spread data sequence and time-multiplexing the at least one spread data sequence with the at least one RS, to generate a multiplexed sequence. Further, the method comprises generating an OTFDM symbol using the multiplexed sequence.

Also, embodiments of the present disclosure relate to a method for receiving a waveform. The method comprising performing, by the receiver, a Fast Fourier Transform (FFT) on received time multiplexed waveform to obtain a transformed sequence. Also, the method comprises performing de-mapping operation using a plurality of sub-carriers to generate a de-mapped sequence. Further, the method comprises estimating a channel using the de-mapped sequence based on an estimation method and equalizing the de-mapped sequence using the estimated channel to obtain an equalized sequence. Further, de-spreading the equalized sequence to obtain a de-spread input data/control information.

The present disclosure provides a waveform technology that not only addresses this critical issue of reducing PAPR, improving user multiplexing ability through spreading, improving energy efficiency but also achieves one of the major goals of future wireless communication systems i.e., extremely low latency.

Embodiments of the present disclosure provides a waveform which allows data/control information, to be transmitted with low PAPR, high PA efficiency, low latency. Also, spreading operation is used with OTFDM, this is because the spreading operation helps reduce other user/cell interference, increases signal-to-noise-plus-interference-ratio (SINR), increases user multiplexing ability. Low latency is obtained from entire system operation point of view.

Embodiments of the present disclosure provides a waveform that allows time division multiplexing of data/control and RS within a single OFDM symbol (TDM within a OFDM Symbol). The generated symbol is referred to as orthogonal time frequency division multiplexing (OTFDM) symbol, which is designed for information exchange taking place in one shot transmission.

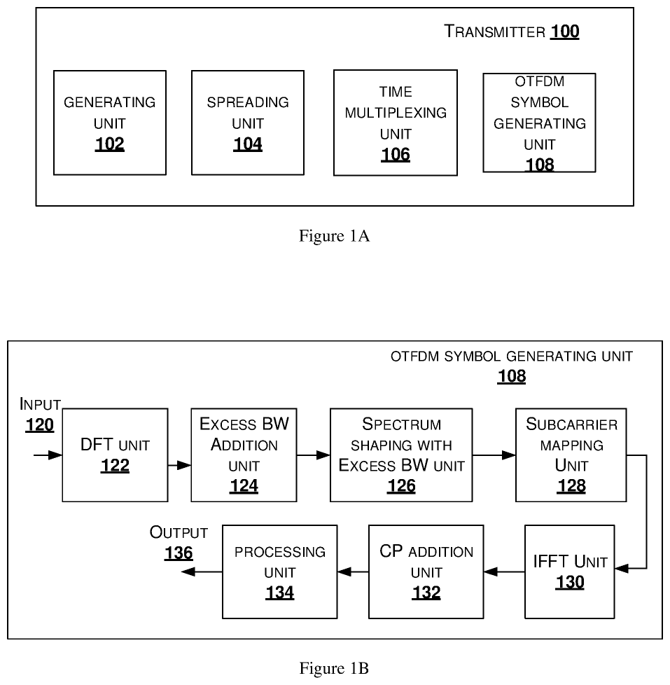

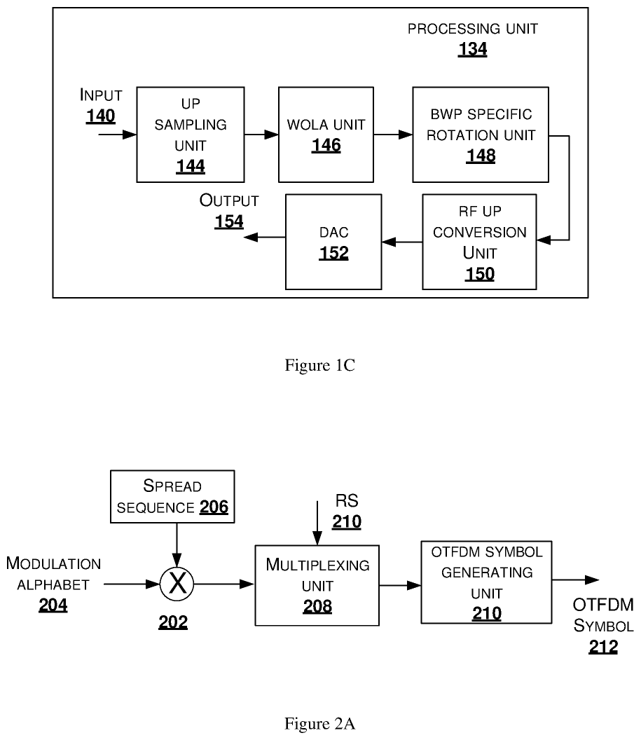

FIG. 1A shows a block diagram of an OTFDM transmitter, in accordance with an exemplary embodiment of the present disclosure. The OTFDM transmitter is referred to as a transmitter or a communication system. The transmitter or communication system 100 comprises a processor and memory coupled with the processor (not shown in the figure). The processor may be configured to perform one or more functions of the communication system for receiving input data and generate waveform for transmitting to a receiver. In one implementation, the communication system may comprise units or blocks or modules for performing various operations in accordance with the embodiments of the present disclosure.

As shown in the FIG. 1A, the transmitter 100 comprises a generating unit 102, a spreading unit 104, time multiplexing unit 106 and an OTFDM symbol generating unit 108. The time multiplexing unit 102 is also referred as a time multiplexer or multiplexer or time division multiplexer or TDM. The OTFDM symbol generating unit 108 is also referred as OTFDM symbol generator or symbol generator.

The generating unit 102 generates at least one of: at least one input data and at least one reference sequence (RS). The at least one input data is also referred as data sequence or input data. The at least one input data includes at least one of a user data and a control information. The control information is also referred as control or control data or control data sequence. The at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. Each of the at least one data sequence includes at least one data, and at least one of a data cyclic prefix and a data cyclic suffix.

The at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence.

In an embodiment, each of the at least one RS sequence includes at least one RS chunk, at least one of a RS cyclic prefix and a RS cyclic suffix, size of the RS cyclic prefix is one of at least half of the RS chunk size and an arbitrary value, size of the RS cyclic suffix is one of at least half of the RS chunk size and an arbitrary value. The arbitrary value is 0 or ¼th of RS chunk size or any other value which may be pre-defined in specification or explicitly signalled between transmitter or receiver or implicitly understood based on the size of the RS. When the arbitrary value is zero, the RS CP or RS CS inclusion is disabled.

The spreading unit 104 receives the at least one input data that is spread using a spread sequence to generate at least one spread data sequence. The technique of spreading may be generalized to transmission of one or more than 1 bit where each bit is mapped to a respective modulation alphabet and is spread using a spreading sequence, in one embodiment. The at least one input data includes one or more modulation alphabets in an embodiment.

In an embodiment, the input data is spread over multiple spread sequences within the OTFDM symbol and across OTFDM symbols. Each of the multiple spread sequences is one of identical and different. Each of the at least one spread sequence is a shift version sequence of the other at least one spread sequence, and are orthogonal to each other. The spread sequence is determined by at least one of a first index, a second index and an OTFDM symbol number, in an embodiment. The first index is a function of at least one of base station specific index and sector specific index associated with a transmitter. The second index is a circular shift. In an embodiment, the at least one spread data sequence is multiplied with one or more transmitter specific orthogonal code covers to obtain one or more transmitter specific spread data sequence. In an embodiment, the multiple transmitters may refer to different antenna ports or beams of a user's, or antenna ports or beams of different users, or different base stations etc. The input data from multiple transmitters are multiplexed on a plurality of OTFDM symbols. The transmitter specific modulation alphabets may be spread on to a pre-defined spread sequences to obtain the transmitter specific spread data sequences. The spread sequence corresponding to each transmitter may be obtained from the same base sequence or from different sequences. Additionally, each transmitter specific spread sequence may be multiplied with a transmitter specific orthogonal code covers.

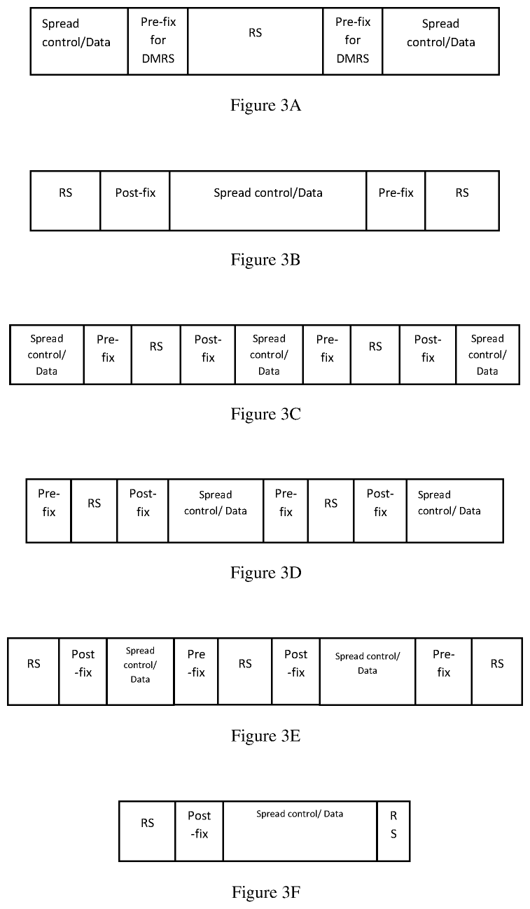

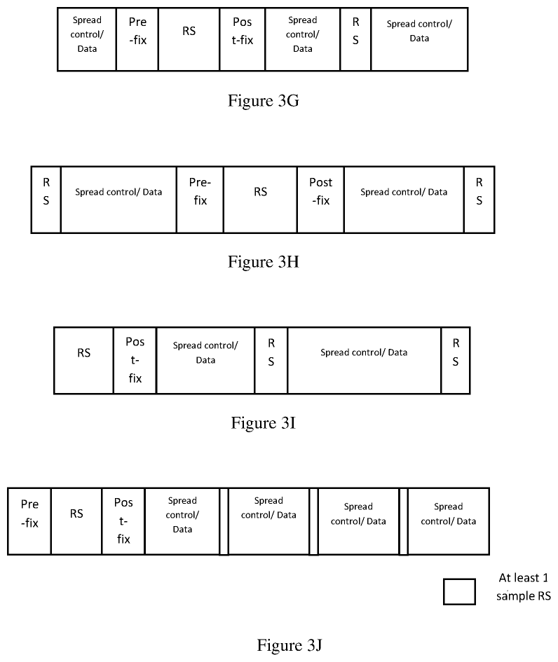

The time multiplexing unit 106 performs time-multiplexing of the at least one spread data sequence with the at least one RS, to generate a multiplexed sequence. The multiplexed sequence is also referred to as time multiplexed sequence or TDM sequence. The symbols shown in FIGS. 3A-3J are the multiplexed sequences obtained using time multiplexer 106.

The OTFDM symbol generating unit 108 generates an output called as OTFDM symbol using the multiplexed sequences. In an embodiment, when the transmitter 100 comprises a plurality of antennas, the multiplexed sequence is fed to the OTFDM symbol generating unit 108, to generate a OTFDM symbols specific to a particular antenna port or a beam. The symbol generated is transmitted by one of a specific antenna port or beam from the plurality of antenna ports or beams.

FIG. 1B shows a block diagram of an OTFDM symbol generating unit, in accordance with an embodiment of the present disclosure. As shown in the FIG. 1B, the OTFDM symbol generating unit 104 comprises a Discrete Fourier Transform (DFT) unit 122, an excess BW addition unit 124, a spectrum shaping with excess BW unit 126, a sub-carrier mapping unit 128, an inverse Fast Fourier transform (FFT) unit 130, a cyclic prefix (CP) addition unit 132 and a processing unit 134.

The DFT unit 122 transforms an input 120 i.e. multiplexed sequence using a Discrete Fourier Transform (DFT) to generate a transformed multiplexed sequence.

The excess BW addition unit 124 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping with excess BW unit 126, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 128, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence. In an embodiment, the location of the subcarriers that are mapped to available subcarriers is specific to the transmitter or antenna port or beam or user.

The IFFT unit 130 performs inverse IFFT on the shaped extended bandwidth transformed multiplexed sequence to produce a time domain sequence. The CP addition unit performs an addition of symbol cyclic prefix on the time domain sequence to generate time domain sequence with CP, which is processed by the processing unit 134 to generate an OTFDM symbol.

FIG. 1C shows a block diagram of a processing unit of the OTFDM symbol generating unit as shown in FIG. 1B, in accordance with an exemplary embodiment of the present disclosure. As shown in FIG. 1C, the processing unit 134 comprises an up sampling unit 144, a weighted with overlap and add operation (WOLA) unit 146, a bandwidth parts (BWP) specific rotation unit 148, a RF up-conversion unit 150, and a digital to analog converter (DAC). In an embodiment, WOLA and BWP rotation operations may be omitted.

The processing unit 134 processes the time domain sequence with CP to generate an OTFDM symbol. The processing comprises performing at least one of a symbol specific phase compensation, up sampling using the up-sampling unit 144, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152, to generate the output OTFDM symbol or OTFDM waveform 154. The generated OTFDM symbol offers low PAPR. The OTFDM symbol is generated using spreading operation on the input data, the spreading helps in reducing the other user interface, increases user multiplexing ability, increases SINR and offers low PAPR. The spectrum shaping of excess BW reduces the PAPR and increases the overall transmission power.

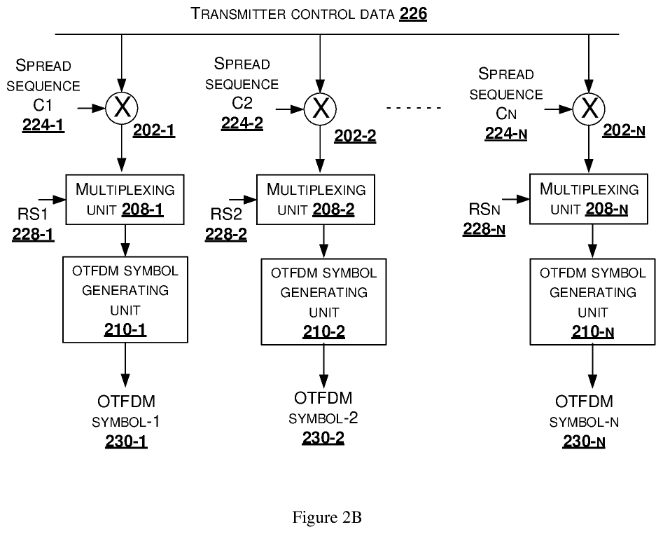

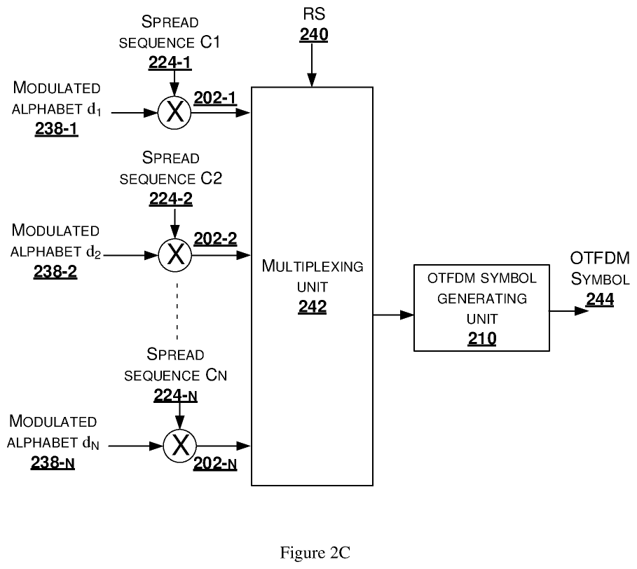

FIG. 2A shows the generation of a single OTFDM symbol, in accordance with an embodiment of the present disclosure.

As shown in the FIG. 2A, the input is the modulation alphabet 204 which is spread using spread sequence 206 to generate a spread data sequence using a multiplier 202. The spread sequence 206 is also referred to as spreading sequence or spread code or spreading code. The spread data sequence is also referred to as spread data or spreaded data sequence or spreaded data. The spread data is time multiplexed with reference sequence (RS) 210 using the multiplexing unit 208 to generate multiplexed sequence. Thereafter, the multiplexed sequence is processed using the OTFDM symbol generating unit 210 to generate a single OTFDM symbol 212.

One embodiment of the present disclosure is generation of OTFDM symbol for spread control/data transmission. In this method, the input data for symbol generation may be either control information or user data. Also in an embodiment, the data is either related to control messages such as, but not limited to acknowledgement (ACK) or negative acknowledgement (NACK), a channel quality indicator (CQI), Scheduling Request (SR) or transmitter specific information in uplink.

The generated modulation alphabets may be spread on to a pre-defined spread sequence to obtain the spread data sequence. The spreading operation may involve multiplication of the spread sequence with the modulated alphabets. The spread sequence may be one of a pi/2-BPSK sequence, QPSK sequence, PSK sequence, and ZC sequence. The sequences may be obtained using one of m-sequences, PN sequences, Kasami, Walsh, and Hadamard codes. The length of the spread sequence used may be a function the allocated subcarriers for the data transmission. The spread sequence may be one of the base sequences, and an orthogonal cover code may be applied on it to obtain the final spread sequence. The modulation alphabets are multiplied with the respective spread sequences to obtain a spread data sequence. Since each alphabet is spread onto a pre-determined sequence, intra and inter cell interference can be randomised. This helps in improving the Signal to Interference and Noise Ratio (SINR). Hence, spreading offers better data decoding. The spread data sequence may be appended with cyclic prefix (CP), or Cyclic Suffix (CS), or both Cyclic Prefix (CP), and Cyclic Suffix (CS).

FIG. 2B shows the generation of one or more OTFDM symbols, in accordance with an embodiment of the present disclosure.

An embodiment of the present disclosure is multi symbol generation i.e. As shown in FIG. 2B, the generation of multiple OTFDM symbols is performed using spread data sequence multiplexed with symbol specific RS. The input data for each symbol generation may be same or different, and each symbol carries one modulation alphabet of input data. The input data (modulation alphabet) of each symbol may be spread using a spread sequence. The spread sequence may be same across all the symbols, or the spread sequence may be different across all the symbols. The spread sequence across symbols may be orthogonal to each other. In an embodiment, orthogonal cover codes may be applied on the spread sequences. Specifically, if the same spread sequence is employed on all the OTFDM symbols, then orthogonal cover codes may establish the orthogonality across the symbols. The input data is multiplied with spread sequence to obtain spread data sequence. The length of the spread sequence used is a function of the number of modulated alphabets within the symbol, and the allocated subcarriers for the input data transmission. The modulation alphabets are multiplied with the respective spread sequences (224-1, 224-2, . . . 224-N) to obtain a spread data sequence. The spread data sequence corresponding to each modulation alphabet may be appended with cyclic prefix (CP), or Cyclic Suffix (CS), or both Cyclic Prefix (CP), and Cyclic Suffix (CS).

To facilitate the decoding of the spread data sequence, spread data sequence in each symbol is multiplexed with symbol specific RS sequence (228-1, 228-2, . . . 228-N). The multiplexed symbol corresponding to each symbol is fed to corresponding OTFDM symbol generating unit (210-1, 210-2, . . . , 210-N) is DFT precoded before processing using a processing unit to obtain symbol specific corresponding OTFDM symbols (230-1, 230-2, . . . , 230-N).

FIG. 2C shows the generation of OTFDM symbols with multiple input samples, in accordance with another embodiment of the present disclosure.

As shown in FIG. 2C, generation of the OTFDM symbol is performed with the input data samples and spread sequences. In this method, each symbol may have multiple modulated alphabets d₁ (238-1), d₂ (238-2), . . . d_{N} (238-N). The input data may be either control information or transmitter/user specific data.

Each modulated alphabet may be spread on to a pre-defined spread sequence to obtain the spread data sequence. Since there is more than one alphabet in one OTFDM symbol, there may be multiple spread sequences (224-1, 224-2, . . . 224-N), each corresponding to respective modulated alphabet (238-1, 238-2, . . . , 238-N). The spread sequences may be obtained from the same base sequence or from different base sequences. The spreading operation may involve multiplication of the spread sequence with the modulated symbol. The modulation alphabets are multiplied using corresponding multipliers 202-1, 202-2, . . . , 202-N with the respective spread sequences, and the resultant spread sequences are multiplexed to obtain a lengthy spread data sequence. The length of the spread sequence used is a function of the number of modulated alphabets within the symbol, and the allocated subcarriers for the input data transmission. The spread data sequence corresponding to each modulation alphabet may be appended with cyclic prefix (CP), or Cyclic Suffix (CS), or both Cyclic Prefix (CP), and Cyclic Suffix (CS). In another embodiment, rather than appending the cyclic prefix (CP), or Cyclic Suffix (CS) to each spread data sequence, only one CP, or CS, or both CP and CS corresponding to the lengthy spread data sequence is appended to the lengthy spread data sequence. Since, each alphabet is spread onto a pre-determined sequence, intra and inter cell interference can be randomized. This helps in improving the Signal to Interference and Noise Ratio (SINR), user multiplexing ability. Hence, spreading offers better data decoding.

To facilitate the decoding of the spread data sequence, the spread data sequence is appended with RS sequence. The position of RS may be in the center or starting or ending of the OTFDM symbol. This kind of RS may be referred as long/main/localized RS. To support better channel estimation either cyclic pre-fix (RS-CP) or cyclic post-fix (RS-CS) or both pre-fix and post-fix may be added to the RS in the time domain. The Frequency spectrum of RS should be as flat as possible to ensure reliable channel estimation. RS and RS-CP or RS-CS may occupy a portion of resources allocated to the transmitter, which may depend on properties of channel conditions, Excess bandwidth, transmitter allocation size, modulation order, coding rate, and other parameters like impulse response of spectrum shaping filter. FIG. 3A shows a symbol with RS in the middle of OTFDM symbol along with pre-fix and post-fix. In an embodiment, the RS-CP and RS-CS may be absent in a symbol or absent in the system.

In another embodiment, a multiple RS blocks may be used while multiplexing RS with data. Each of the multiple RS blocks is a transmitter specific RS. One possible way is to keep more than one block of RS samples with each block having same number of samples. The RS block occupies any positions in the symbol, like shown the FIGS. 3B to 3E, which are for 2 blocks and 3 blocks. However, it may be extended to any number of blocks and any other configuration. RS in each block may be the same sequence or different. This kind of each RS block may be referred as long/main/localized/primary RS block, and all the blocks will either have both RS pre-fix and RS-post-fix or RS-post-fix or RS-pre-fix. Each block will be used for channel estimation and the transmitter data followed by the block will be equalized with the channel that is estimated. This kind of design helps in tracking the high Doppler channel or phase error caused by the crystal oscillator, which may vary within an OTFDM symbol. When RS samples are at the symbol boundaries, they may not need either RS-pre-fix or RS-post-fix. The different main block RS may be adjacent to each other or separated. In an embodiment, the RS-CP and RS-CS may be absent in a symbol or absent in the system.

In another embodiment, the size of each block is different. Here, size of one block may be larger, while the sizes of all the other blocks may be small or even simply once sample. The main block with larger RS sizes may have RS-pre-fix or RS-post-fix or both RS-pre-fix and RS-post-fix. Main RS block will be used for channel estimation, while the smaller blocks may be used for phase tracking with in the OTFDM symbol. The smaller RS blocks may be referred as distributed/secondary/phase tracking RS block also. The smaller block RS samples may be at least one sample obtained from the main RS block or obtained from separately generated sequences.

FIGS. 3F and 3G shows the symbol structure with two RS blocks, while one has both RS-Pre-fix and RS-post-fix, while the other block has no RS-CP. Similar symbol structure 3 RS blocks are show in FIGS. 3H to 3J. Similar structure may be extended for any number of blocks. The block is a transmitter specific RS, in an embodiment. The smaller RS block may have only one sample obtained from one of the samples of the one of the main RS blocks or may be a separately generated sequence. in an embodiment, at least one of the RS blocks may include orthogonal cover codes, where the RS blocks are applied with transmitter specific orthogonal cover codes. The RS multiplexed with spread data sequence in OTFDM symbol comprising of spread data sequence and RS may have one of at least one main RS block and one secondary RS block. In an embodiment, the RS-CP and RS-CS may be absent in a symbol or absent in the system.

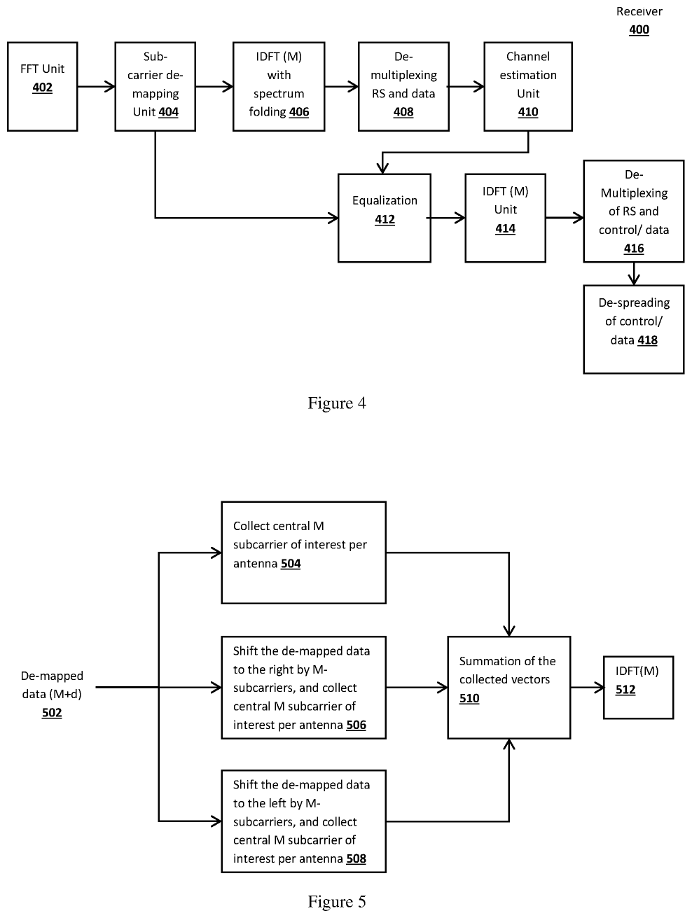

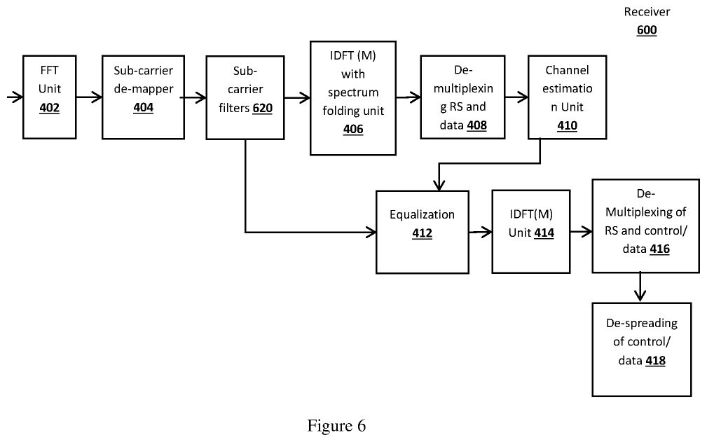

One embodiment of the present disclosure is a receiver. A block diagram illustration of a receiver is shown in FIGS. 4 to 8. FIG. 4 shows a block diagram of a receiver 400 for receiving Data and RS multiplexed in one OTFDM symbol, with spectrum shaping and excess bandwidth. FIG. 6 shows a receiver receiving for Data and RS multiplexed in one OTFDM symbol with spectrum extension shaping and receiver spectrum shaping.

As shown in FIGS. 4 and 6, at the receiver 400 or 600 the received signal is first processed with front processing elements like an analog to digital convertor (ADC), a cyclic prefix (CP) removal, a phase de-rotation or decompensation and a Fast Fourier Transform (FFT) 402. The allocated sub-carriers are de-mapped in the sub-carrier de-mapper or subcarrier de-mapping unit 404, where M+d allocated sub-carriers are de-mapped from entire FFT output. If spectrum shaping performed at the transmitter is with square root of the frequency response of the spectrum shaping filter or filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver is called as “subcarrier filters”. The subcarrier filter is one of SQRC, RC, Hanning, Hamming, Blackman, or LGMSK pulses, or square root of these pulses. The filter may be obtained by generating the filter using one of the above-mentioned filters to lengths greater than M+d, and truncating the generated filter to M+d length.

The spectrum shaping filter 620 used by the transmitter and receiver are the same and is indicated (or pre-determined/a priori agreed) between the UE and BS. One example of such a filter is square root raised cosine pulse which is applied in the frequency domain (in both Tx and Rx sides).

From M+d size de-mapped data Y(k), M samples are obtained either by picking the central M samples or using one of the two identical methods by folding the spectrum. In the first method, M samples are obtained from M+d samples by taking modified IDFT of size M, which is given by the following expression.

$$\tilde{Y} ( k ) = \frac{1}{\sqrt{M}} {\sum }_{k = 0}^{M + d - 1} Y ( k ) {e}^{\frac{j 2 π ( k - \frac{d}{2} ) n}{M}}$$

The second method, which is equivalent to the above expression involves the following steps.
From the de-mapped data Y(k), central M-subcarriers are collected and labelled as Y₁(k).
The de-mapped data is left shifted by M-subcarriers to collect central M-subcarriers which is labelled as Y₂(k).
The de-mapped data is right shifted by M-subcarriers to collect central M-subcarriers which is labelled as Y₃(k).

Effective received data of size M is obtained by adding all the above collected data. The effective data is given by the expression:

$$\tilde{Y} ( k ) = {Y}_{1} ( k ) + {Y}_{2} ( k ) + {Y}_{3} ( k )$$

This procedure is encapsulated in FIG. 5. The FIG. 5 is an illustration of obtaining M samples from M+d samples. In cases where the excess number of subcarriers is more than M, additional circularly shifted components (2M, 3M etc.) will be included in the above expression.

An IDFT 406 of size M is taken over the effective data \tilde{Y}(k) to obtain the received data in time-domain, where Data and RS are de-multiplexed using De-multiplexing RS and data unit 408. The De-multiplexing RS and data is also referred as de-multiplexing unit 408. The received RS samples are used for channel estimation using channel estimation unit 410. The estimation may be performed by Least Squares method, or Least Squares followed by time-domain interpolation. The estimated channel obtained from RS will be used for equalizing, using equalization unit or equalizer 412, the de-mapped data of size M using an equalizer like MMSE. An IDFT 414 of size M is performed on the equalized data to obtain multiplexed RS and data in time-domain.

The data is de-multiplexed using de-multiplexed of RS and control/data unit 416, which is processed with de-spreading of control/data unit 418 to obtain the transmitted modulation alphabet, which is sent for further processing to obtain the transmitted control/data, where, the further processing involves at least one of the Log Likelihood Ratio (LLR) computation, LLR scaling, De-scrambling, De-interleaving, Forward error correction, Hybrid ARQ, Cyclic Redundancy Check (CRC). The receiver architecture for this is as shown in FIG. 4. The receiver architecture for receiver filtering is as shown in FIG. 6. If spectrum extension is not performed at the transmitter, An IDFT of size M is performed on the de-mapped without any intermediate processing.

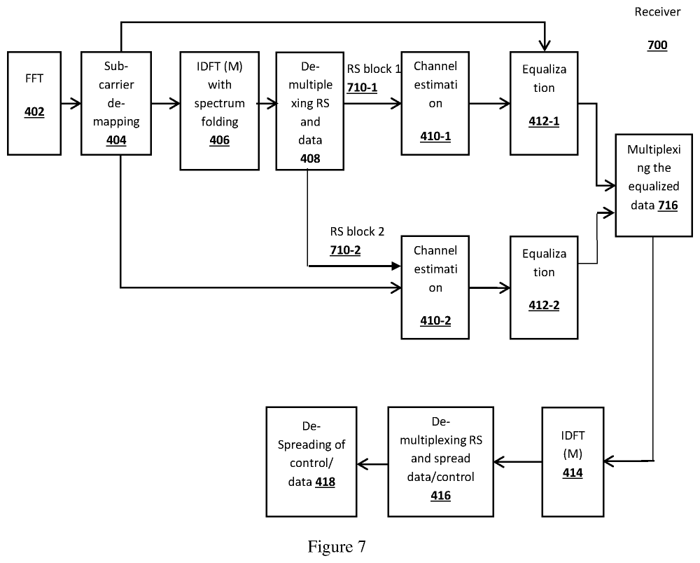

When multiple RS blocks with either RS-CP/CS or both with RS-CP and RS-CS are transmitted, channel estimation is performed on all the RS blocks. The estimated channel on each block will be used for equalizing the transmitter data which is located immediately adjacent to the RS block. In the case where multiple non-contiguous RS blocks are multiplexed in an OTFDM symbol, distinct data blocks can be arranged such that, each data block is equalized from the derived channel estimates of the respective RS block as show in FIG. 7.

FIG. 7 shows a block diagram of a receiver for receiving two RS blocks, with estimation on each RS block. As shown in FIG. 7, the front end processing is performed on the received signal flowed by FFT, subcarrier de-mapping, IDFT, De-multiplexing RS and data. Considering the output of de-multiplexing is two RS blocks 710-1, 710-2. Channel estimation units 410-1, 410-2 performs channel estimation using the RS-blocks 710-1, 710-2, followed by multiplexing of the equalized data using multiplexing the equalized data unit 716, to obtain the equalized modulation alphabets corresponding to input control/data after IDFT, De-multiplexing of RS and control/data and de-spreading of control/data.

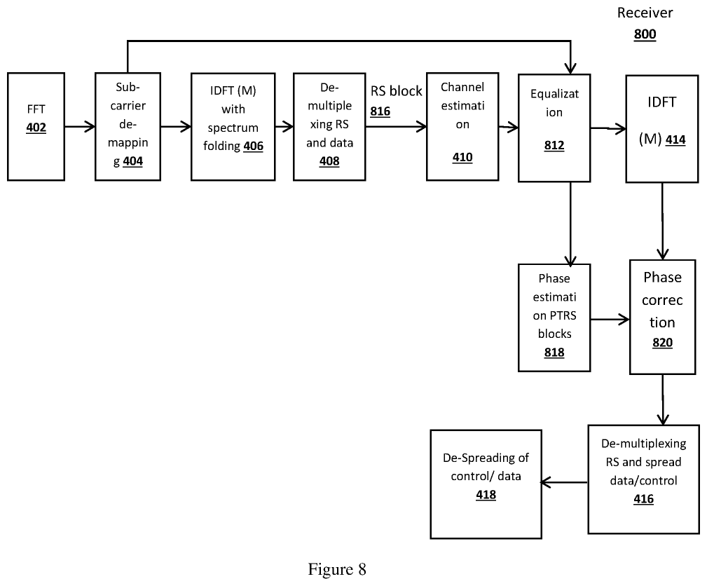

However, when multiple RS blocks of different sizes are transmitted, the block with relatively larger size will be used for channel estimation, and subsequently for symbol equalization. The smaller RS blocks are used to track phase changes using Phase estimation PTRS blocks 818, if any on the equalized data. If any significant phase changes are obtained, the same will be corrected using phase correction unit 820. The corresponding receiver architecture is as shown in FIG. 8. The receiver architecture shown in FIG. 8 is for two RS blocks; however, it may be extended for any number of RS blocks. At least one of the RS blocks may include orthogonal cover codes, where the RS blocks are applied with transmitter specific orthogonal cover codes.

In an embodiment, the OTFDM symbol may transmit only RS sequence without data/control multiplexing. This type of OTFDM RS symbol may be used for sensing applications. The RS-CP or RS-CP may be not included with the RS and the CP after IFFT may also be absent.

In another embodiment, a slot comprises of multiple contiguous OTFDM symbols where the amount of spreaded data/control information and RS is different in each symbol. Some symbols may carry RS only, some symbols may carry spreaded data/control only and some symbol may carry both spreaded data/control and RS.

In the following embodiments a method of design of spreading sequences that can be used as RS or for the purpose of spreading control or data is provided.

In this method a base sequence that is obtained by taking a BPSK sequence that goes through pi/2 constellation rotation. Various cyclic shifts of the base sequence may be used as inputs. The base sequences and the number of cyclic shifts that result in low PAPR and low correlation among the base sequences and zero correlation among the cyclic shifts of a base sequence may be obtained through a computer search. The base sequences are optimized such that the generated waveforms have optimized or low PAPR. The time domain computer generated BPSK base sequences are illustrated in the below Table 1.

TABLE 1

| S. | |
|---|---|
| No. | Sequence |
| 1 | 1 −1 −1 −1 −1 1 −1 1 −1 −1 1 1 |
| 2 | −1 −1 −1 −1 −1 1 1 −1 −1 1 −1 1 |
| 3 | −1 −1 −1 −1 1 −1 −1 1 1 1 −1 1 |
| 4 | 1 −1 −1 −1 1 −1 1 1 1 −1 −1 1 |
| 5 | −1 −1 −1 −1 1 1 −1 1 −1 −1 −1 1 |
| 6 | 1 −1 −1 1 −1 −1 −1 1 −1 1 1 −1 |
| 7 | 1 −1 −1 1 1 −1 1 1 1 1 −1 1 |
| 8 | 1 1 −1 −1 −1 1 −1 −1 −1 −1 1 1 |
| 9 | −1 1 −1 1 1 −1 −1 −1 −1 1 −1 −1 |
| 10 | −1 1 1 −1 1 −1 1 1 1 1 1 −1 |
| 11 | −1 1 1 1 −1 1 −1 −1 −1 −1 1 −1 |
| 12 | 1 −1 1 1 −1 −1 1 1 1 1 1 −1 |
| 13 | −1 −1 −1 −1 1 −1 −1 −1 1 −1 1 1 |
| 14 | 1 −1 −1 −1 1 1 −1 −1 1 −1 1 −1 |
| 15 | 1 −1 −1 1 −1 −1 −1 −1 1 1 −1 1 |
| 16 | −1 −1 −1 1 −1 −1 1 1 1 −1 1 −1 |
| 17 | 1 −1 −1 1 −1 1 1 1 1 −1 1 1 |
| 18 | −1 −1 1 −1 −1 −1 −1 1 −1 1 1 1 |
| 19 | −1 −1 1 −1 1 1 −1 −1 −1 −1 1 −1 |
| 20 | −1 −1 1 1 −1 1 −1 −1 −1 1 −1 −1 |
| 21 | 1 1 −1 −1 1 1 −1 −1 −1 −1 −1 1 |
| 22 | 1 −1 1 −1 −1 −1 1 1 −1 1 1 1 |
| 23 | 1 1 −1 1 −1 1 1 1 1 1 −1 −1 |
| 24 | 1 1 1 1 1 −1 1 −1 1 1 −1 −1 |
| 25 | 1 −1 −1 −1 1 −1 1 −1 −1 1 1 −1 |
| 26 | −1 −1 −1 1 −1 1 1 −1 −1 −1 −1 1 |
| 27 | 1 −1 −1 1 −1 1 1 1 −1 −1 1 −1 |
| 28 | 1 −1 −1 1 1 −1 −1 1 −1 1 −1 −1 |
| 29 | 1 −1 −1 1 1 −1 1 −1 −1 −1 1 −1 |
| 30 | 1 −1 1 −1 −1 1 1 1 −1 1 −1 −1 |

In an embodiment for using 1 or 2 bit UCI (user control information) transmission, UCI is mapped to BPSK or QPSK symbol and the symbol is spreaded using a spreading code selected from Table-1. The index of the code may be signalled by the base station as a circular shift of a base pi/2 BPSK sequence or a ZC sequence.

The RS sequence may also be allocated from the Table 1 and may be signalled by the base station as a circular shift of a base pi/2 BPSK sequence or a ZC sequence. The data/control may be spreading using Walsh-Hadamard sequences of a given size or orthogonal DFT sequences.

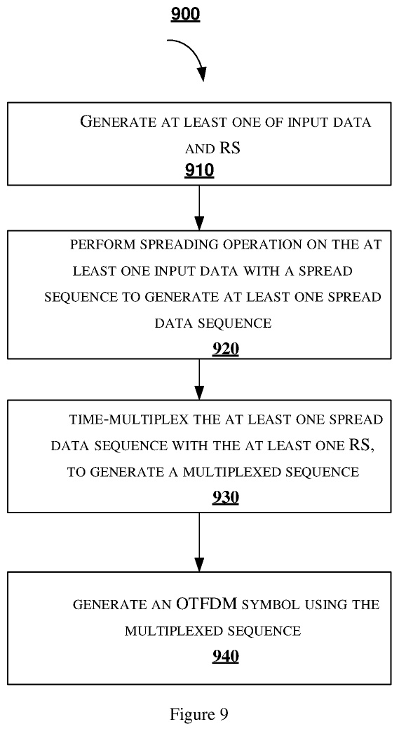

FIG. 9 shows a flowchart illustrating a method for transmitting a waveform in a communication network, in accordance with some embodiments of the present disclosure.

As illustrated in FIG. 9, the method 900 comprises one or more blocks for transmitting a waveform. The method 900 may be described in the general context of computer executable instructions. Generally, computer executable instructions can include routines, programs, objects, components, data structures, procedures, modules, and functions, which perform functions or implement abstract data types.

The order in which the method 900 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 910, generating, by a transmitter, at least one of: at least one data sequence and at least one reference sequence (RS). The at least one input data includes at least one of a user data and a control information. The at least one data sequence is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. In an embodiment, the at least one data sequence includes at least one of a user data and a control information. Each of the at least one data sequence includes at least one data, and at least one of a data cyclic prefix and a data cyclic suffix.

The at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. In an embodiment, each of the at least one RS sequence includes at least one RS chunk, at least one of a RS cyclic prefix and a RS cyclic suffix, size of the RS cyclic prefix is one of at least half of the RS chunk size and an arbitrary value, size of the RS cyclic suffix is one of at least half of the RS chunk size and an arbitrary value

At block 920, performing spreading operation on the at least one input data with a spread sequence to generate at least one spread data sequence.

At block 930, time-multiplexing the at least one spread data sequence with the at least one RS, to generate a multiplexed sequence.

At block 940, generating an OTFDM symbol using the multiplexed sequence comprising transforming the multiplexed sequence using a Discrete Fourier Transform (DFT) to generate a transformed multiplexed sequence. Next, performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. Also, the generating comprises mapping the extended bandwidth transformed multiplexed sequence with at least one of localized and distributed subcarriers to generate a mapped extended bandwidth transformed multiplexed sequence. Further, shaping the mapped extended bandwidth transformed multiplexed sequence using a filter to obtain a shaped extended bandwidth transformed multiplexed sequence. Thereafter, performing an Inverse Fast Fourier Transform (IFFT) on the shaped extended bandwidth transformed multiplexed sequence to produce a time domain sequence and processing the time domain sequence to generate the OTFDM symbol.

The advantages of the OTFDM symbol are that the spectrum shaping of excess BW reduces the PAPR and increases the overall transmission power. Also, multiple RS blocks can be multiplexed to track the channel. In one embodiment, a “long RS block” can be used to the estimate the overall channel impulse response and “short RS blocks” (including single pilot) can be distributed over the span of the symbol to track the phase changes. Alternatively, multiple RS blocks of equal length can be used to estimate the channel locally and equalize the adjacent data blocks.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting a waveform, comprising:
generating, by a transmitter, at least one of: at least one input data and at least one reference sequence (RS);
performing spreading operation, by the transmitter, on the at least one input data with a spread sequence to generate at least one spread data sequence;
time-multiplexing, by the transmitter, the at least one spread data sequence with the at least one RS, to generate a multiplexed sequence; and
generating, by the transmitter, an OTFDM symbol using the multiplexed sequence.

2. The method as claimed in claim 1, wherein the at least one input data is one of a pi/2 binary phase shift keying (BPSK) sequence, a BPSK sequence, a Quadrature Phase Shift Keying (QPSK) sequence, M-ary Quadrature Amplitude Modulation (QAM) sequence, and an Mary Phase Shift Keying (PSK) sequence.

3. The method as claimed in claim 1, wherein the spread code is one of Binary Phase Shift Keying (BPSK) spreading sequence, Zadoff-Chu (ZC) sequence, Quadrature Phase Shift Keying (QPSK) sequence, and Walsh Hadamard sequence.

4. The method as claimed in claim 1, wherein the at least one input data includes at least one of a user data and a control information.

5. The method as claimed in claim 1, wherein the method comprises performing a spreading operation on the at least one RS is with a transmitter specific code to generate a spread RS.

6. The method as claimed in claim 1, wherein each of the at least one spread sequence is a shift version sequence of the other at least one spread sequence, and are orthogonal to each other.

7. The method as claimed in claim 1, wherein the spread sequence is determined by at least one of a first index, a second index and an OFDM symbol number.

8. The method as claimed in claim 7, wherein the first index is a function of at least one of base station specific index and sector specific index associated with a transmitter.

9. The method as claimed in claim 7, wherein the second index is a circular shift.

10. The method as claimed in claim 1, wherein the at least one data sequence includes one or more modulation alphabets.

11. The method as claimed in claim 1, wherein the at least one spread sequence is applied on the input data.

12. The method as claimed in claim 1, wherein the input data is spread over multiple spread sequences across OTFDM symbols.

13. The method as claimed in claim 12, wherein each of the multiple spread sequences is one of identical and different.

14. The method as claimed in claim 1, wherein the input data from multiple transmitters are multiplexed on a plurality of OTFDM symbols.

15. The method as claimed in claim 1, wherein at least one spread data sequence is multiplied with one or more transmitter specific orthogonal code covers to obtain one or more transmitter specific spread data sequence.

16. The method as claimed in claim 1, wherein the at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence.

17. The method as claimed in claim 1, wherein the at least one RS is multiplied with one or more transmitter specific code covers to obtain one or more transmitter specific RS.

18. The method as claimed in claim 17 wherein each of the one or more transmitter specific code covers is one of a binary phase shift keying (BPSK) sequence, a Walsh Hadamard sequence, PN sequences, a DFT sequence, and a phase ramp sequence.

19. The method as claimed in claim 17, wherein each of the one or more transmitter specific code cover is based on at least one of a transmitter specific antenna port, scrambling ID, symbol ID, slot number, and cell ID.

20. The method as claimed in claim 17, wherein each of the one or more transmitter specific code covers are orthogonal to each other.

21-40. (canceled)
